(19) United States
(12) Patent Application Publication
(10) Pub. No.: US 2025/0392395 A1
(43) Pub. Date: Dec. 25, 2025

(54) QUANTUM RECEIVERS FOR ENTANGLEMENT ASSISTED CLASSICAL OPTICAL COMMUNICATIONS

(71) Applicant: Arizona Board of Regents on Behalf of the University of Arizona, Tucson, AZ (US)

(72) Inventor: Ivan Djordjevic, Tucson, AZ (US)

(21) Appl. No.: 18/877,469

(22) PCT Filed: Jun. 20, 2023
(86) PCT No.: PCT/US2023/068723

§ 371 Date: Dec. 20, 2024

Related U.S. Application Data
(60) Provisional application No. 63/353,752, filed on Jun. 20, 2022.

(51) Int. Cl. H04B 10/67; H04B 10/70

(52) U.S. Cl. CPC H04B 10/67; H04B 10/70

(57) ABSTRACT

A joint quantum receiver for entanglement assisted communication, assuming that the optical-phase conjugation is performed on transmitter side. The joint quantum receiver may base on a balanced beam splitter or an optical hybrid. A signal mode âₛ and an idler mode âᵢ are directly mixed on the BBS or the optical hybrid to form a mixed beam, and the BBS or optical hybrid splits the mixed beam into a first beam and a second beam and outputs the first and second beams to the balanced detector. The balanced detector detects either in-phase or quadrature components. For heterodyne detection, the 2-D entanglement assisted detection scheme is provided.

### TECHNICAL FIELD

The present disclosure is generally related to optical communications and more specially related to quantum receiver for entanglement assisted classical optical communications.

### BACKGROUND INFORMATION

Quantum Information Processing (QIP) opens new avenues for various applications including high performance computing, high-precision sensing, and secure communications.

Among various QIP features, the entanglement represents unique features, including enabling quantum-enhanced sensors with measurement sensitivities exceeding the classical limit; providing certifiable security for data transmissions whose security is guaranteed by the quantum mechanics laws rather than unproven assumptions used in cryptography based on computational security, and enabling quantum computers capable of solving the problems that are numerically intractable for classical computers. In particular, the Entanglement Assisted (EA) can be used to improve the classical channel capacity, enable secure communications, improve sensor sensitivity, and enable distributed provably-secure quantum computer access.

Even though that the optimum encoding, achieving the EA channel capacity has been known, the design of optimum quantum receiver appears to be still an open problem. It has been proposed to use the multiple sections of the feedforward sum-frequency generation (FF-SFG) receiver and to detect the target in highly noisy environment, and although this scheme is suitable for use in quantum binary discrimination problems, it is not an EA channel capacity achieving scheme. Namely, to achieve the EA channel capacity, they have transmitted the same binary information over D=10⁶ bosonic modes thus occupying the whole C and L bands as well as the portion of S band.

### BRIEF DESCRIPTION OF THE DRAWINGS

These and other features and advantages will be better understood by reading the following detailed description, taken together with the drawing, wherein:

FIG. 1 illustrates the entanglement assisted classical optical communication concept assuming that entanglement distribution is done through an all-fiber-based quantum network;

FIG. 2 illustrates the entanglement assisted classical optical communication system model;

FIG. 3 illustrates the operation principle of OPA based receiver;

FIG. 4 illustrates the operation principle of the OPC receiver;

FIG. 5 illustrates the BBS joint balanced detection receiver;

FIG. 6a illustrates a 2×2 optical hybrid based joint balanced detection receiver;

FIG. 6b illustrates a 2×2 optical hybrid implementation in integrated optics of the 2×2 optical hybrid based joint balanced detection receiver illustrated in FIG. 6a;

FIG. 7 illustrates a 2×4 optical hybrid based joint receiver suitable for demodulation of arbitrary 2-D constellation;

FIG. 8 illustrates a joint receiver suitable for demodulation of arbitrary 2-D constellation implemented using 3 dB directional couplers-based 2×4 optical hybrid;

FIG. 9 illustrates the capacity improvements of proposed EA schemes over Holevo capacity vs. number of signal-idler modes;

FIG. 10 illustrates the capacity improvements of proposed EA schemes over Holevo capacity vs. number of signal-idler modes, for different system parameters compared to FIG. 9; and

FIG. 11 illustrates the EA capacity improvements over Holevo, homodyne, heterodyne, and proposed EA optical hybrid-based joint receiver capacities vs. the average number of signal photons.

### DETAILED DESCRIPTION

The present disclosure is generally related to low-complexity, high-performance joint quantum receivers for entanglement assisted communication. The joint quantum receiver may include a balanced beam splitter, which comprises a balanced beam splitter (BBS) and a balanced detector, wherein a signal mode âₛ and âᵢ idler mode di are directly mixed on the BBS to form a mixed beam, and the BBS splits the mixed beam into a first beam and a second beam and outputs the first and second beams to the balanced detector.

The joint quantum receiver may include an optical hybrid. The joint quantum receiver may comprise a 2×2 optical hybrid and a balanced detector, wherein the optical hybrid comprises two input and two output Y-junctions, a signal mode âₛ and an idler mode âᵢ are directly mixed on the optical hybrid to form a mixed beam, and the optical hybrid splits the mixed beam into a first beam and a second beam and outputs the first and second beams to the balanced detector.

In an entanglement assisted classical optical communication system, an optimum encoding based on Gaussian Modulation (GM) of the signal photon in two-mode-squeezed-vacuum (TMSV) state as well as a generic EA communication system of interest may be used.

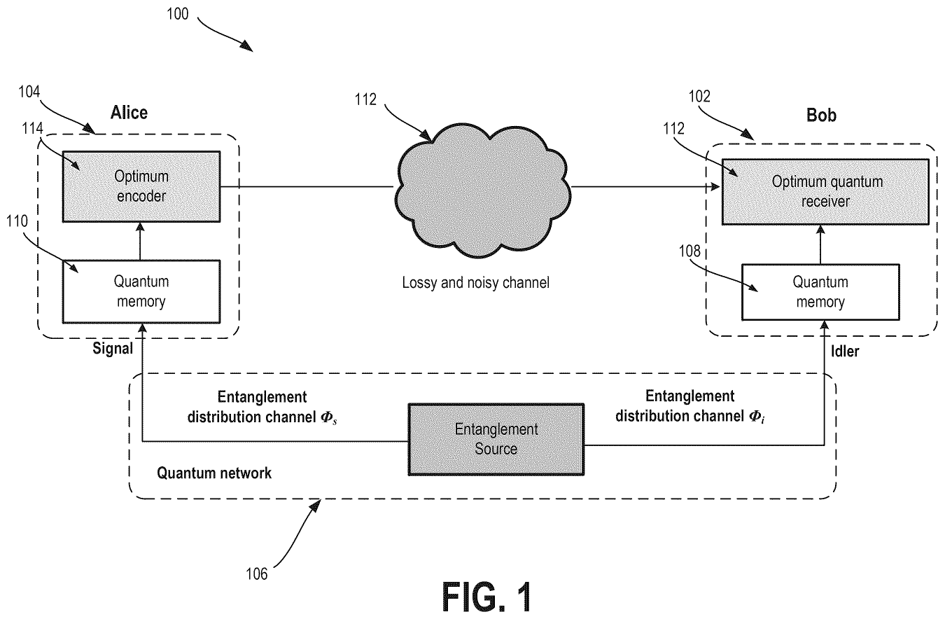

FIG. 1 shows an entanglement assisted classical optical communication system 100, illustrating communication between Bob 102 and Alice 104. In this example, entanglement distribution is done through an all-fiber-based quantum network 106. As illustrated in FIG. 1, an all-fiber based quantum network 106 is used to distribute the entangled states to Bob 102 and Alice 104, which are stored in respective quantum memories 108/110 and used when needed. On the transmitter side, Alice 104 includes an encoder 114 to encode a signal photon of entangled pair and transmits the classical data, imposed on the signal photon over lossy and noisy quantum channel 112. On the receiver side, Bob 102 includes a quantum receiver 112 to employ an entangled idler photon to decide on what was transmitted on signal photon.

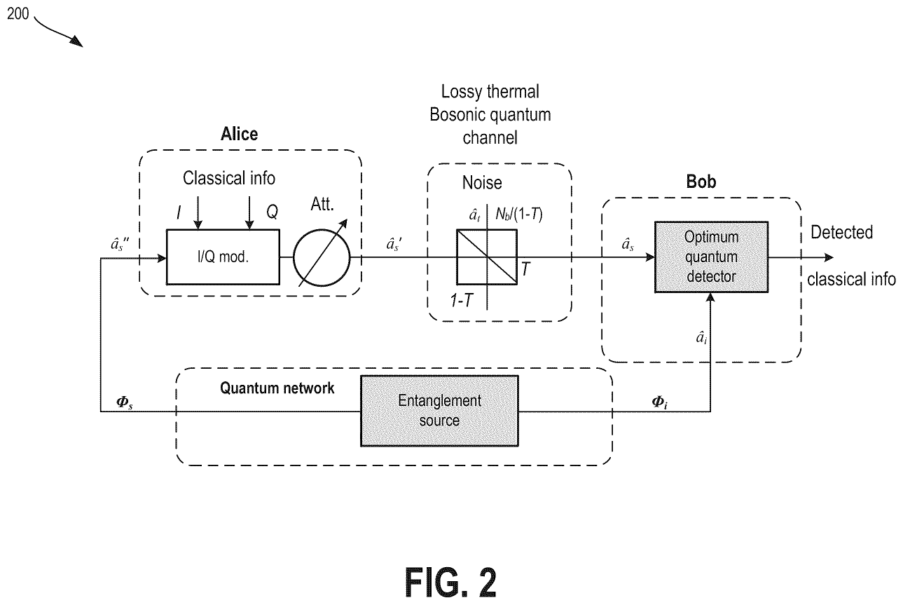

The corresponding model of an optical communication system 200 for EA classical communication is provided in FIG. 2, where the pre-shared entanglement is distributed using two channels: signal channel denoted by ϕₛ and the idler channel denoted by ϕᵢ. Each signal-idler mode pair has a corresponding signal and idler annihilation operators as being âₛ and âᵢ. With an assumption that quantum error correction is applied to protect the quantum states stored in quantum memories against decoherence effects, the Alice-to-Bob channel is modelled by the single-mode thermal lossy Bosonic channel model as shown in equation (1), wherein T is the transmissivity of the main channel, while â_{b} is a background thermal mode with the mean photon number being N_{b}/(1−T). Evidently this channel can also be interpreted as a zero-mean additive white Gaussian noise (AWGN) channel with power-spectral density of N_{b} and attenuation co-efficient being T.

$${\hat{a}}_{s} = \sqrt{T} {\hat{a}}_{s}^{’} + \sqrt{1 - T} {\hat{a}}_{b} , \qquad ( 1 )$$

Alice modulates a signal mode âₛ″ with the help of an I/Q modulator, as shown in FIG. 2, by performing Gaussian Modulation (GM).

With further assumption that two-mode Gaussian states, to be used in EA communication, are generated by the continuous-wave spontaneous parametric down-converter (SPDC) entangled-photon source. In this example, it may be assumed that the optical-phase conjugation (OPC) operations are performed on transmitter side. The SPDC-based entangled source is a broadband source with D=Tₘ Wi. i. d. signal-idler mode pairs, with W being the phase-matching bandwidth and Tₘ is the measurement interval. Each signal-idler mode pair, with corresponding signal and idler annihilation operators being âₛ and âᵢ, is a two-mode squeezed state (TMSV) whose representation in Fock basis is given by equation (2) wherein

$${N}_{s} = 〈 {\hat{a}}_{s}^{†} {\hat{a}}_{s} 〉 = 〈 {\hat{a}}_{i}^{†} {\hat{a}}_{i} 〉$$

denotes the mean photon number per mode. The signal-idler entanglement is specified by the phase-sensitive cross-correlation (PSCC), which, after OPC operations are performed at the transmitter, is defined as

$${C}_{si} = 〈 {\hat{a}}_{s}^{†} {\hat{a}}_{i} 〉 = \sqrt{{N}_{s} ( {N}_{s} + 1 )} ,$$

which represents the quantum limit.

$${{{\vert ψ 〉}_{s , i} = \frac{1}{\sqrt{{N}_{s} + 1}} {\sum }_{n = 0}^{∞} {( \frac{{N}_{s}}{{N}_{s} + 1} )}^{n / 2} \vert n 〉}_{s} \vert n 〉}_{i} , \qquad ( 2 )$$

The TMSV is a pure maximally entangled zero-mean Gaussian state with Wigner covariance matrix being equation (3), wherein 1 is the identity matrix and Z=diag(1, −1) is the Pauli Z-matrix. Clearly, in low-brightness regime Nₛ<<1, the PSCC is Cₛᵢ≈\sqrt{Nₛ} that is much larger than the classical limit Nₛ. The coordinates for the GM are generated from a zero-mean 2-D Gaussian distribution in the digital domain, a digital-to-analog converter (DAC) is used to represent the samples, which are further used as RF inputs of the I/Q modulator. The Gaussian samples are properly scaled to account for the I/Q modulator insertion loss such that average number of transmitted signal photons per mode is equal to

$${N}_{s} = 〈 {( {\hat{a}}_{s}^{’} )}^{†} {\hat{a}}_{s}^{’} 〉 .$$

$${Σ}_{TMSV} = [ \begin{matrix}( 2 {N}_{s} + 1 ) 1 & 2 \sqrt{{N}_{s} ( {N}_{s} + 1 )} Z \\ 2 \sqrt{{N}_{s} ( {N}_{s} + 1 )} Z & ( 2 {N}_{s} + 1 ) 1\end{matrix} ] , \qquad ( 3 )$$

FIG. 2 illustrates the entanglement assisted classical optical communication system model, including I/Q modulator which is marked as I/Q mod, and optional attenuator which is marked as Att. in the figure. Given that the action of the beam splitter (BS), describing the quantum channel, can be represented by

$$BS ( τ ) = [ \begin{matrix}\sqrt{τ} 1 & \sqrt{1 - τ} 1 \\ - \sqrt{1 - τ} 1 & \sqrt{τ} 1\end{matrix} ] ,$$

in order to determine the covariance matrix after the beam splitter in entanglement distribution channel as shown in FIG. 2 a known symplectic operation may be applied by equation (4) shown below:

$${BS}_{c} ( T ) = 1 ⊕ B S ( T ) = [ \begin{matrix}1 & 0 & 0 \\ 0 & \sqrt{T} 1 & \sqrt{1 - T} 1 \\ 0 & - \sqrt{1 - T} 1 & \sqrt{T} 1\end{matrix} ] . \qquad ( 4 )$$

on the input covariance matrix Σ_{TMSV} to obtain:

$${Σ}^{′} = {{BS}_{c} ( T ) [ \begin{matrix}{Σ}_{TMSV} & 0 \\ 0 & {σ}^{2} 1\end{matrix} ] [ B {S}_{c} ( T ) ]}^{T} , \qquad ( 5 )$$

where the variance of thermal state is

$$\frac{{N}_{b}}{1 - T}$$

thermal photons. By keeping Alice and Bob submatrices, equation (6) is obtained:

$${Σ}_{AB} = [ \begin{matrix}( 2 {N}_{s} + 1 ) 1 & 2 \sqrt{{TN}_{s} ( {N}_{s} + 1 )} Z \\ 2 \sqrt{{TN}_{s} ( {N}_{s} + 1 )} Z & ( 2 {N}_{s}^{”} + 1 ) 1\end{matrix} ] , \qquad ( 6 )$$

where

$${N}_{s}^{”} = {N}_{s} T + {N}_{b} .$$

In nonlinear receiver entanglement assisted communication, an optical parametric amplifier (OPA) may be used as the basic building block in corresponding joint receivers.

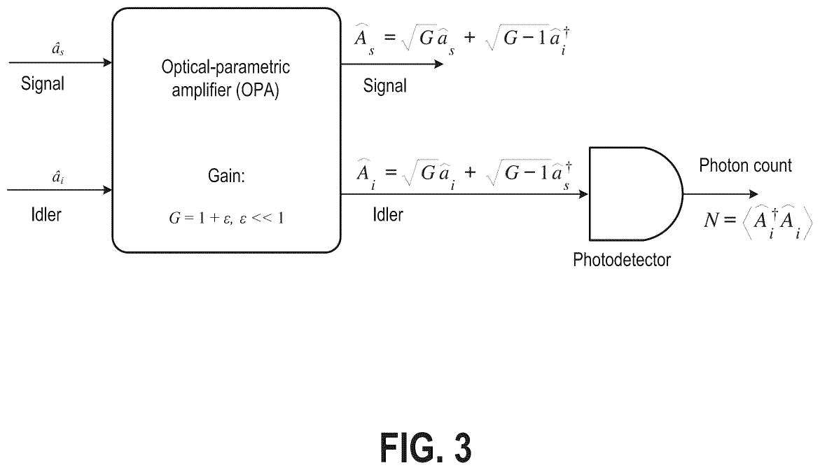

A joint measurement receiver may use the optical parametric optical amplifier (OPA), shown in FIG. 3, wherein the gain is selected as G=1+ε, ε<<1. Each signal-idler mode pair has a corresponding signal and idler annihilation operators as being âₛ and âᵢ. The signal mode and idler mode âₛ and âᵢ are both input into the optical-parametric amplifier (OPA), and the idler output of the OPA is detector by a photodetector. The photons are detected at the port where idler is amplified.

The idler output of the OPA may be given as equation (7):

$${\hat{A}}_{i} = \sqrt{G} {\hat{a}}_{i} + \sqrt{G - 1} {\hat{a}}_{s}^{†} , \qquad ( 7 )$$

Assuming that M-ary PSK is imposed by the I/Q modulator, the signal mode at the output modulator âₛ′ is related to the input mode of modulator âₛ″ by âₛ′=e^{Jφ}âₛ″ where φ is the phase shift introduced by the modulator. The photodetector output operator is given by:

$$\begin{matrix}\hat{i} = {RA}_{i}^{†} {\hat{A}}_{i} = R ( \sqrt{G} {\hat{a}}_{i}^{†} + \sqrt{G □ 1} {\hat{a}}_{s} ) ( \sqrt{G} {\hat{a}}_{i} + \sqrt{G □1} {\hat{a}}_{s}^{†} ) \\ = R [ G {\hat{a}}_{i}^{†} {\hat{a}}_{i} + \sqrt{G ( G □1 )} {\hat{a}}_{i}^{†} {{e}^{□ j φ} ( {\hat{a}}_{s}^{″} )}^{†} + \sqrt{G ( G □1 )} {e}^{j φ} {\hat{a}}_{s}^{″} {\hat{a}}_{i}^{″} + ( G □1 ) \text{?}\end{matrix} \qquad ( 8 )$$

$$\text{?} \text{indicates text missing or illegible when filed}$$

R is the photodiode responsivity, and the “□” symbol represents a minus (−) sign. Without loss of generality in this application, we assume that

$$R = \frac{1 A}{W} .$$

The expected value of the photocurrent operator is related to the photon count average by:

$$\begin{matrix}\hat{i} = 〈 {A}_{i}^{†} {\hat{A}}_{i} 〉 \\ = {GN}_{i} + {e}^{- j φ} \sqrt{G ( G - 1 )} {C}_{si} + {e}^{j φ} \sqrt{G ( G - 1 )} {C}_{si} + ( G - 1 ) ( {N}_{s}^{”} + 1 ) \\ = {GN}_{s} + 2 \sqrt{G ( G - 1 )} cos φ + ( G - 1 ) ( {N}_{s}^{”} + 1 ) ,\end{matrix} \qquad ( 9 )$$

Nᵢ=Nₛ is valid for the TMSV state. The photocurrent average is proportional to cos φ and detection of the transmitted phase is possible. However, there are also two noise terms.

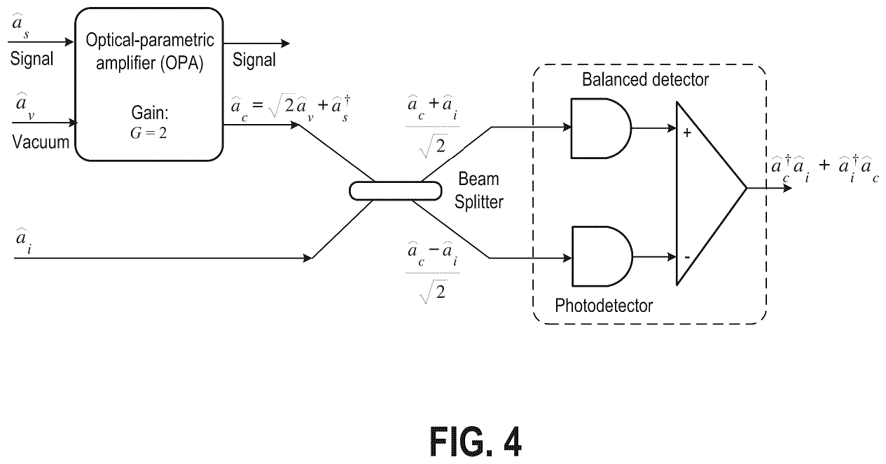

Given that OPA receiver is not suitable for balanced detection, an optical phase-conjugate (OPC) receiver shown in FIG. 4 may be used. This scheme is applicable when OPC operations are not performed on transmitter side.

Here the OPA is used to nonlinearly interreact the signal mode as with the vacuum mode âᵥ to get the following output at the idler port

$${\hat{a}}_{c} = \sqrt{G} {\hat{a}}_{v} + \sqrt{G - 1} {\hat{a}}_{s}^{†} ,$$

which when gain G=2, it is simplified to

$${\hat{a}}_{c} = \sqrt{2} {\hat{a}}_{v} + {\hat{a}}_{s}^{†} .$$

Next by performing the mixing of the ac-mode with the idler mode on a balanced beam splitter (BBS) followed by the balanced detection (BD), the following BD photocurrent operator is obtained.

$$\begin{matrix}{\hat{i}}_{BD} = \frac{1}{2} ( {\hat{a}}_{c}^{†} + {a}_{i}^{†} ) ( {\hat{a}}_{c} + {\hat{a}}_{i} ) - \frac{1}{2} ( {\hat{a}}_{c}^{†} - {\hat{a}}_{i}^{†} ) ( {\hat{a}}_{c} - {\hat{a}}_{i} ) \\ = {\hat{a}}_{c}^{†} {\hat{a}}_{i} + {\hat{a}}_{i}^{†} {\hat{a}}_{c} , ,\end{matrix} \qquad ( 10 )$$

With submitting the expression for ac-mode equation (11) is obtained.

$${\hat{i}}_{BD} = \sqrt{2} {\hat{a}}_{v}^{†} {\hat{a}}_{i} + {\hat{a}}_{s} {\hat{a}}_{i} + \sqrt{2} {\hat{a}}_{i}^{†} {\hat{a}}_{v} + {\hat{a}}_{i}^{†} {\hat{a}}_{s}^{†} , \qquad ( 11 )$$

For M-ary PSK,

$${\hat{a}}_{s}^{′} = {e}^{j φ} {\hat{a}}_{s}^{′′} ,$$

and given that the vacuum mode and the idler mode are uncorrelated, the following expression for the expectation of the BD photocurrent operator is obtained.

$$〈 {\hat{i}}_{Bd} 〉 = {e}^{j ϕ} {〈 {\hat{a}}_{s}^{″} {\hat{a}}_{i} 〉}_{{C}_{si}} + {e}^{□ j ϕ} \text{?} cos φ , \qquad ( 12 )$$

$$\text{?} \text{indicates text missing or illegible when filed}$$

Where the “□” symbol represents a minus (−) sign. Therefore, it cancels the noise terms in single-detector case as shown in equation (9). The variance of the BD photocurrent operator will be:

$$\begin{matrix}Var ( {\hat{i}}_{BD} ) = 〈 {\hat{i}}_{BD}^{2} 〉 - {〈 {\hat{i}}_{BD} 〉}^{2} \\ = {N}_{i} {N}_{s}^{”} + ( {N}_{i} + 1 ) ( {N}_{s}^{”} + 1 ) + 2 {C}_{si}^{2} cos ( 2 φ ) - 4 {C}_{si}^{2} {cos}^{2} φ .\end{matrix} \qquad ( 13 )$$

For binary PSK (BPSK) the expression for variance is simplified to:

$${Var}^{( BPSK )} ( {\hat{i}}_{BD} ) = {N}_{i} {N}_{s}^{”} + ( {N}_{i} + 1 ) ( {N}_{s}^{”} + 1 ) - 2 {C}_{si}^{2} , \qquad ( 14 )$$

Further, in low-brightness and highly noisy regime where Nₛ<<1 and N_{b}>>1, the following expression for variance is obtained:

$${Var}^{( BPSK )} ( {\hat{i}}_{BD} ) \approx ( 2 {N}_{s} + 1 ) {N}_{b} , \qquad ( 15 )$$

The corresponding expression for bit error probability will be

$${P}_{b}^{( BPSK )} = \frac{1}{2} erfc ( \sqrt{\frac{4 T {N}_{s} ( {N}_{s} + 1 )}{( 2 {N}_{s} + 1 ) {N}_{b}}} ) , \qquad ( 16 )$$

The erfc(.) is used to denote the complementary error function, defined by

$$erfc ( u ) = ( 2 / \sqrt{π} ) {\int }_{u}^{∞} exp ( - {x}^{2} ) dx .$$

Given that the SPDC-based entangled source is broadband source, by employing D modes all modulated with the same BPSK signal, the bit error probability can be reduced:

$${P}_{b}^{( BPSK )} ( D ) = \frac{1}{2} erfc ( \sqrt{\frac{4 {DTN}_{s} ( {N}_{s} + 1 )}{( 2 {N}_{s} + 1 ) {N}_{b}}} ) , \qquad ( 17 )$$

The corresponding binary symmetric channel capacity per mode is:

$${C}_{OPC}^{( BPSK )} = \frac{1}{D} [ 1 - h ( {P}_{b}^{( BPSK )} ( D ) ) ] , \qquad ( 18 )$$

The h(x) is the binary entropy function, defined by h(x)=−x log₂ x−(1−x)log₂(1−x).

The entanglement assisted communication represents an interesting alternative to classical communication, which in low-brightness and highly noisy regime can significantly outperform corresponding classical counterparts in terms of the channel capacity. Even though that the EA capacity is known for decades the optimum quantum receiver has not been determined yet, although some progress has been made recently.

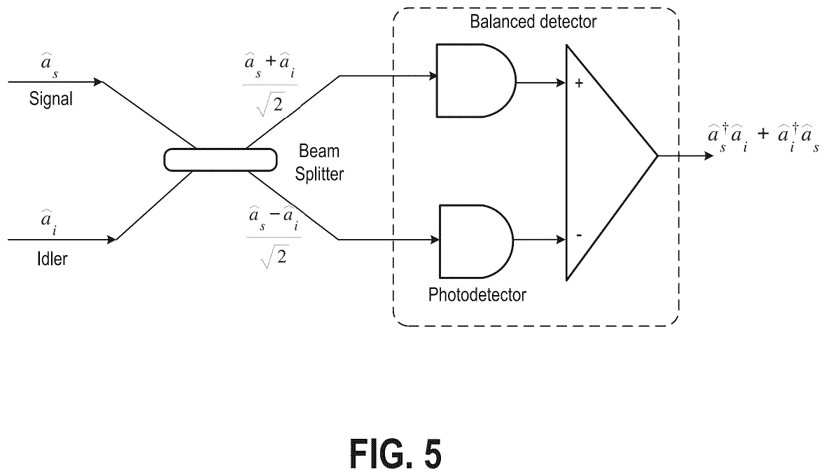

The below embodiments of joint receiver schemes can achieve comparable or better performance, while being of lower complexity and not requiring the OPA as the building block. For example, based on equations (10) and (11) for the OPC receiver, there is no correlation between the signal and vacuum modes and what really matters is the mixing of the signal and idler modes directly on BBS as shown in FIG. 5. Assuming that the OPC is performed on a transmitter side, the signal mode and idler mode âₛ and âᵢ are input and mixed on the BBS, and the signal output and idler output from the BBS may respectively be

$$\frac{{\hat{a}}_{s} + {\hat{a}}_{i}}{\sqrt{2}} and \frac{{\hat{a}}_{s} - {\hat{a}}_{i}}{\sqrt{2}} .$$

Both the output and idler output from the BBS are detected by the balanced detector. The balanced detector includes two photodetectors and an operational amplifier. Therefore, BD photocurrent operator is simplified as:

$${\hat{i}}_{BD} = {\hat{a}}_{s}^{†} {\hat{a}}_{i} + {\hat{a}}_{i}^{†} {\hat{a}}_{s} , \qquad ( 19 )$$

For M-ary PSK, the equations (12)-(18) for OPC receiver may be applied here. This receiver is identical to the coherent detection receiver, wherein instead of the local oscillator (LO) laser signal, the idler mode is used. Therefore, different coherent detection receivers are directly applicable.

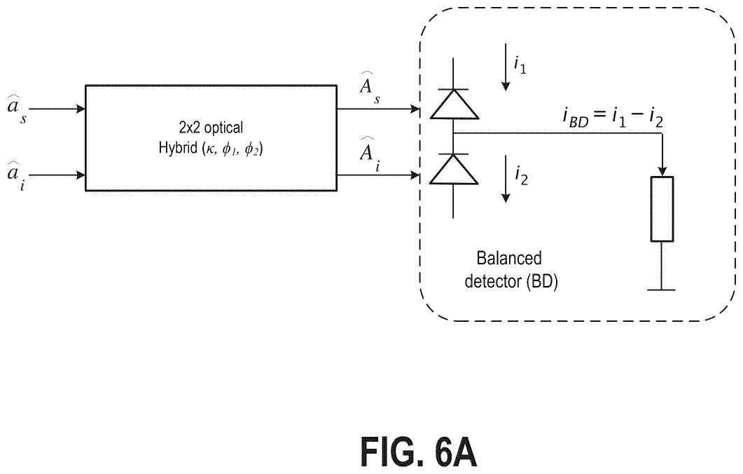

In another embodiment, an optical hybrid (OH) based joint balanced detection scheme is illustrated in FIGS. 6a and 6b. It is suitable for implementation in integrated optics and as such is compatible with the quantum nanophotonic.

FIG. 6(a) provides the configuration is 2×2 optical hybrid-based BD, while FIG. 6(b) provides the corresponding integrated optics implementation of 2×2 OH implementation in integrated optics. The OH has two phase trimmers to introduce the phase shifts ϕ₁ and ϕ₂, respectively.

The optical hybrid is composed of two input and two output Y-junctions, and the scattering matrix can be described by:

$$S = [ \begin{matrix}{e}^{j {ϕ}_{1}} \sqrt{1 - κ} & \sqrt{1 - κ} \\ \sqrt{κ} & {e}^{j {ϕ}_{2}} \sqrt{κ}\end{matrix} ] , \qquad ( 20 )$$

where κ is the power splitting ratio of Y-junctions, and this matrix transforms input signal and idler modes to:

$$[ \begin{matrix}{\hat{A}}_{s} \\ {\hat{A}}_{i}\end{matrix} ] = S [ \begin{matrix}{\hat{a}}_{s} \\ {\hat{a}}_{i}\end{matrix} ] , \qquad ( 21 )$$

In particular, for the power splitting ratio κ=½ this transformation is simply:

$$[ \begin{matrix}{\hat{A}}_{s} \\ {\hat{A}}_{i}\end{matrix} ] = \frac{1}{\sqrt{2}} [ \begin{matrix}{e}^{j {ϕ}_{1}} & 1 \\ 1 & {e}^{j {ϕ}_{2}}\end{matrix} ] [ \begin{matrix}{\hat{a}}_{s} \\ {\hat{a}}_{i}\end{matrix} ] , \qquad ( 22 )$$

Assuming that arbitrary 2-D constellation is used, the signal mode at the output of I/Q modulator âₛ′ is related to the input mode of modulator âₛ″ by âₛ′=sâₛ″, where s=s₁+js_{Q} is the 2-D signal constellation point. For instance for M-ary PSK, s=exp(jφ). Based on FIG. 6(a), the balanced detector outputs the current difference between the included two photodetectors, and the following balanced detector photocurrent operator is obtained:

$${\hat{i}}_{BD} = \frac{1}{2} {s}^{†} ( {e}^{- j {ϕ}_{1}} - {e}^{j {ϕ}_{2}} ) {( {a}_{s}^{”} )}^{†} {a}_{i} + \frac{1}{2} {s}^{†} ( {e}^{- j {ϕ}_{1}} - {e}^{j {ϕ}_{2}} ) {a}_{i}^{†} {a}_{s}^{”} , \qquad ( 23 )$$

The expectation of photocurrent operator is given by:

$$〈 {\hat{i}}_{BD} 〉 = \frac{1}{2} {s}^{†} {C}_{si} ( {e}^{- j {ϕ}_{1}} - {e}^{j {ϕ}_{2}} ) + \frac{1}{2} {s}^{†} ( {e}^{- j {ϕ}_{1}} - {e}^{j {ϕ}_{2}} ) {C}_{si} , \qquad ( 24 )$$

In special case, by setting ϕ₁=0 rad and ϕ₂=π, the mean of BD photocurrent operator is:

$$〈 {\hat{i}}_{BD}^{( I )} 〉 = 2 {C}_{si} \text{?} {s}_{I} , \qquad ( 25 )$$

$$\text{?} \text{indicates text missing or illegible when filed}$$

Therefore, the in-phase component s₁ of transmitted signal constellation point is detected. For M-ary PSK Re{s}=cos φ, the equation (12) is obtained. On the other hand, by setting ϕ₁=π/2 and ϕ₂=π/2, the following mean of BD photocurrent operator is obtained:

$$〈 {\hat{i}}_{BD}^{( Q )} 〉 = 2 {C}_{si} \text{?} {s}_{Q} , \qquad ( 26 )$$

$$\text{?} \text{indicates text missing or illegible when filed}$$

Therefore, the quadrature component s_{Q} of transmitted signal constellation point is detected. The joint receiver shown in FIG. 6(a) can be used to determine in-phase and quadrature components by properly setting the control voltages on phase trimmers. The variance of BD photocurrent operator is given by:

$$\begin{matrix}Var ( {\hat{i}}_{BD} ) = 〈 {\hat{i}}_{BD}^{2} 〉 - {〈 {\hat{i}}_{BD} 〉}^{2} \\ = \frac{1}{4} {\vert {e}^{j {ϕ}_{1}} - {e}^{- j {ϕ}_{2}} \vert}^{2} ( 2 {N}_{s}^{”} {N}_{i} + {N}_{s}^{”} + {N}_{i} ) + \\ \frac{{C}_{si}^{2}}{4} [ ( 〈 {s}^{†2} 〉 - {s}^{2} ) {( {e}^{j {ϕ}_{1}} - {e}^{j {ϕ}_{2}} )}^{2} ] + \\ \frac{{C}_{si}^{2}}{2} [ ( 〈 {s}^{2} 〉 - {s}^{2} ) {( {e}^{j {ϕ}_{1}} - {e}^{j {ϕ}_{2}} )}^{2} ] - \frac{{C}_{si}^{2}}{2} {s}^{†} s {\vert {e}^{j {ϕ}_{1}} - {e}^{- j {ϕ}_{2}} \vert}^{2} ,\end{matrix} \qquad ( 27 )$$

The variance of BD is dependent on signal constellation-point. In special case, by setting ϕ₁=0 rad and ϕ₂=π, the following variance of BD photocurrent operator is obtained:

$$Var ( {\hat{i}}_{BD}^{( I )} ) = 2 {N}_{s}^{”} {N}_{i} + {N}_{s}^{”} + {N}_{i} + {C}_{si}^{2} ( 〈 {s}^{†2} 〉 - {s}^{†2} ) + {C}_{si}^{2} ( 〈 {s}^{2} 〉 - {s}^{2} ) - 2 {C}_{si}^{2} {s}^{†} s , \qquad ( 28 )$$

On the other hand, by setting ϕ₁=π/2 and ϕ₂=−π/2, the following variance of BD photo-current operator is:

$$Var ( {\hat{i}}_{BD}^{( Q )} ) = 2 {N}_{s}^{”} {N}_{i} + {N}_{s}^{”} + {N}_{i} - {C}_{s i}^{2} ( 〈 {s}^{†2} 〉 - {s}^{†2} ) - {C}_{s i}^{2} ( 〈 {s}^{2} 〉 - {s}^{2} ) - 2 {C}_{si}^{2} {s}^{†} s , \qquad ( 29 )$$

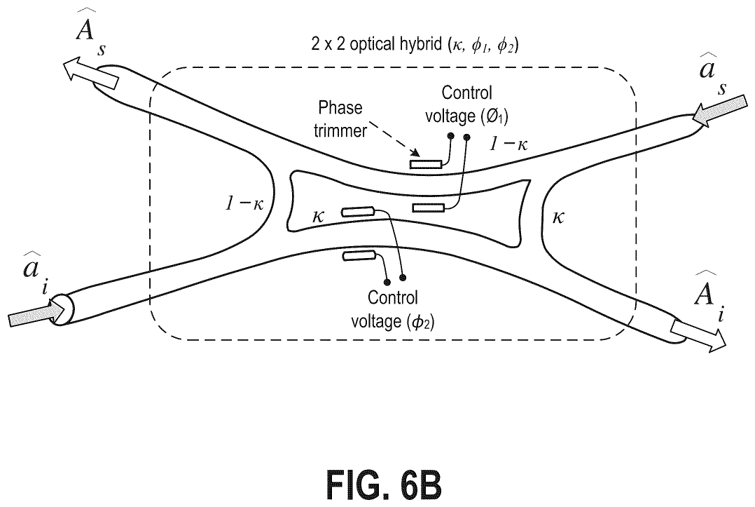

In another embodiment, to simultaneously detect the in-phase and quadrature components, the 2×4 optical hybrid-based joint receiver shown in FIG. 7 may be used. The upper branch and BD are used to detect the in-phase component, while the lower branch and BD are used to detect the quadrature component. Given that two additional Y-junctions are needed, one for signal mode and the second for idler mode, the transmit TMSV state needs to be adjusted so that the equations (25) and (26) can be used to describe mean photocurrents corresponding to in-phase and quadrature components, while equations (28) and (29) to describe the corresponding variances.

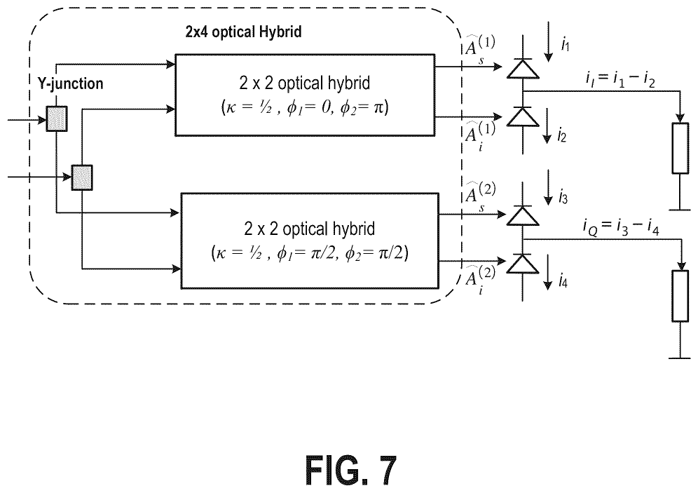

In another embodiment, the corresponding 3 dB directional couplers-based implementation of the joint receiver is provided in FIG. 8.

The scattering matrix of 3 dB directional coupler is known, and is provided as

$$S = {2}^{1 / 2} [ \begin{matrix}1 & j \\ j & 1\end{matrix} ] .$$

Given that vacuum states at unused input ports of 3 dB directional couplers are not correlated to the signal and idler modes, corresponding correlations at balanced detector outputs will be zeros, and to simplify derivation we can ignore the vacuum states. Following similar procedure as in text related to the FIG. 6, the balanced photocurrent operators for in-phase and quadrature components are:

$${\hat{i}}_{BD}^{( I )} = {\hat{a}}_{s}^{†} {\hat{a}}_{i} + {\hat{a}}_{i}^{†} {\hat{a}}_{s} , \qquad ( 30 a )$$

$${\hat{i}}_{BD}^{( Q )} = j ( {\hat{a}}_{s}^{†} {\hat{a}}_{i} - {\hat{a}}_{i}^{†} {\hat{a}}_{s} ) , \qquad ( 30 b )$$

Again, assuming that arbitrary 2-D constellation is used, the signal mode at the output of I/Q modulator is related to the input mode of modulator âₛ″ by âₛ′=sâₛ″, so that the corresponding expectations become:

$$\begin{matrix}〈 {\hat{i}}_{BD}^{( I )} 〉 = 〈 {{s}^{†} ( {\hat{a}}_{s}^{”} )}^{†} {\hat{a}}_{i} + s {\hat{a}}_{i}^{†} {\hat{a}}_{s}^{”} 〉 \\ = ( {s}^{†} + s ) {C}_{si} \\ = 2 Re \{ s \} {C}_{si} \\ = 2 {s}_{I} {C}_{si} ,\end{matrix} \qquad ( 31 a )$$

$$\begin{matrix}〈 {\hat{i}}_{BD}^{( Q )} 〉 = 〈 j ( {{s}^{†} ( {\hat{a}}_{s}^{”} )}^{†} {\hat{a}}_{i} - s {\hat{a}}_{i}^{†} {\hat{a}}_{s}^{”} ) 〉 \\ = j ( {s}^{†} - s ) {C}_{si} \\ = 2 Im \{ s \} {C}_{si} \\ = 2 {s}_{Q} {C}_{si} ,\end{matrix} \qquad ( 31 b )$$

The outputs are proportional to the in-phase s₁ and quadrature s_{Q} components of transmitted signal constellation points. Given that equations in (31a) and (31b) are identical to equations (25) and (26), the variances will be the same as well, and the performance of scheme shown in FIG. 8 will be the identical to that shown in FIG. 7.

Here we evaluate the performance of above EA schemes, employing the Gaussian modulation of signal mode and the proposed joint receiver, and significant channel capacity improvements over corresponding Holevo, homodyne, and heterodyne channel capacities are demonstrated.

For Gaussian modulation described above and 2×4 optical hybrid based joint receiver shown in FIG. 7, the corresponding channel capacity will be:

$$\begin{matrix}C = {log}_{2} ( 1 + \frac{4 {TN}_{s} ( {N}_{s} + 1 ) ( {s}_{I}^{2} + {s}_{Q}^{2} )}{2 ( 2 {N}_{s}^{”} {N}_{i} + {N}_{s}^{”} + {N}_{i} ) - 4 {C}_{si}^{2} {s}^{†} s} ) \\ = {log}_{2} ( 1 + \frac{2 {TN}_{s} ( {N}_{s} + 1 ) ( {s}_{I}^{2} + {s}_{Q}^{2} )}{2 {N}_{s}^{”} {N}_{s} + {N}_{s}^{”} + {N}_{s} - 2 {C}_{si}^{2} {s}^{†} s} ) ,\end{matrix} \qquad ( 32 )$$

The quantum limit of classical capacity may be expressed as:

$${C}_{Holevo} = g ( {TN}_{s} + {N}_{b} ) - g ( {N}_{b} ) , \qquad ( 33 )$$

which is also known as the Holevo capacity, wherein g(x)=(x+1)log₂(x+1)−x log₂ x.

Given that according to the uncertainty principle both in-phase and quadrature components of a Gaussian state cannot be simultaneously measured with the complete precision, for homodyne detection the information is encoded on a single quadrature so that the average number of received photon is 4TNₛ, while the average number of noise photons is 2N_{b}+1, and the corresponding classical capacity for homodyne detection is Cₕₒₘ=0.5 log₂ [1+4TNₛ/(2N_{b}+1)].On the other hand, in heterodyne detection both quadratures are used so that the average number of received signal photons will be 0.5*0.5*4 TNₛ=TNₛ (one-half comes from splitting to two quadratures and second half from heterodyne splitting), while the average number of noise photons per quadrature is (2N_{b}+1)/2+½=N_{b}+1. The corresponding heterodyne channel capacity will be Cₕₑₜ=log₂ [1+TNₛ/(N_{b}+1)]. To achieve the channel capacity in classical case we need to use the GM by generating samples from two uncorrelated zero-mean Gaussian sources and with the help of an arbitrary waveform generator (AWG) impose them on the optical carrier by using an I/Q modulator. To achieve the Holevo capacity we need to use the Gaussian state. For instance the coherent state with GM can achieve the Holevo capacity.

Regarding the EA capacity, by close inspection of equation (6) we conclude that this covariance matrix has the standard form

$$Σ = [ \begin{matrix}a 1 & C \\ C & b 1\end{matrix} ]$$

with

$$a = 2 {N}_{s} + 1 , b = 2 {N}_{s}^{”} + 1 ,$$

C=cZ,c=2\sqrt{TNₛ(Nₛ+1)}, and the symplectic eigenvalues are given by:

$$\begin{matrix}\text{?} = \text{?} \sqrt{{( a + b )}^{2} ▯ 4 {c}^{2}} \text{?} / 2 \\ = \sqrt{{( {N}_{s} + {N}_{s}^{″} + 1 )}^{2} ▯4 {TN}_{s} ( {N}_{s} + 1 )} \text{?} ) ,\end{matrix} \qquad ( 34 )$$

$$\text{?} \text{indicates text missing or illegible when filed}$$

Where the “□” symbol represents a minus (−) sign. The corresponding expression for the entanglement assisted channel capacity is given by:

$${C}_{EA} = g ( {N}_{s} ) + g ( {N}_{s}^{”} ) - [ g ( \frac{{v}_{+} - 1}{2} ) + g ( \frac{{v}_{-} - 1}{2} ) ] , \qquad ( 35 )$$

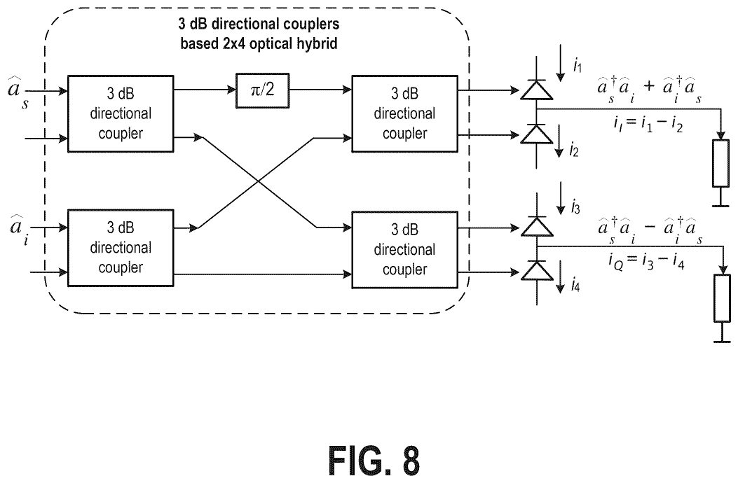

To evaluate the capacity improvement of the proposed optical hybrid-based joint detection scheme over Holevo capacity, for channel transmissivity T=0.1, average number of background photons N_{b}=20, and the average signal photon number Ns=10⁻³. FIG. 9 illustrates the capacity improvements of proposed EA schemes over Holevo capacity vs. number of signal-idler modes. Simulation parameters are selected as follows: channel transmissivity T=0.1, average number of signal photons Nₛ=10⁻³, and average number of background photons N_{b}=20.

This demonstrates that the disclosed scheme for GM outperforms the Holevo capacity by more than two times for number of signal-idler modes up to D=3980. On the other hand, the BPSK based EA scheme employing receiver shown in FIG. 7 outperforms the Holevo capacity >1.3 times for number of signal-idler modes up to 400.

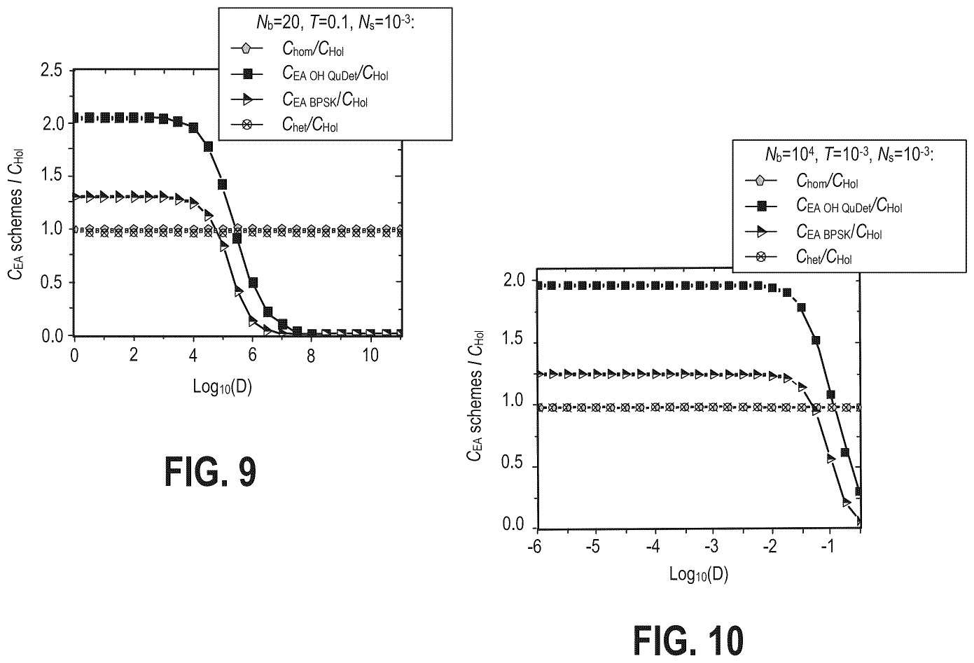

For comparison purposes, FIG. 10 illustrates the capacity improvements of proposed EA schemes over Holevo capacity vs. number of signal-idler modes. Simulation parameters are selected as follows: channel transmissivity T=10⁻³, average number of signal photons N₃=10⁻³, and average number of background photons N_{b}=104. In FIG. 10 we study the capacity improvements of proposed EA schemes for the same set of parameters as FIG. 5 in H. Shi, Z. Zhang, Q. Zhuang, “Practical route to entanglement-assisted communication over noisy Bosonic channels,” Phys. Rev. Appl., vol. 13, no. 3, p. 034029, 2020: channel transmissivity T=10⁻³, average number of signal photons Nₛ=10⁻³, and average number of background photons N_{b}=104. Clearly, the capacity of EA BPSK employing the joint receiver from FIG. 7 outperforms the Holevo capacity by 1.25 times for number of signal-idler modes up to 400. For a number of signal-idler modes ranging from 10⁸ to 10¹¹ this scheme performs comparable to the OPC receiver from above reference, even though it has lower complexity and lower cost. On the other hand, the capacity for GM scheme employing the joint receiver from FIG. 7 outperforms the Holevo capacity by 1.96 times for number of signal-idler modes up to 5000. Interestingly enough, the capacity of proposed scheme is higher than capacity obtained for the FF-SFG receiver, see FIG. 8 in above ref. Shi, which has significantly higher complexity and cost. By close inspection of FIGS. 9 and 10, contrary to ref. Shi, we conclude that for the proposed joint receiver the large number of signal-idler modes is not required; moreover, the single signal-idler pair is sufficient.

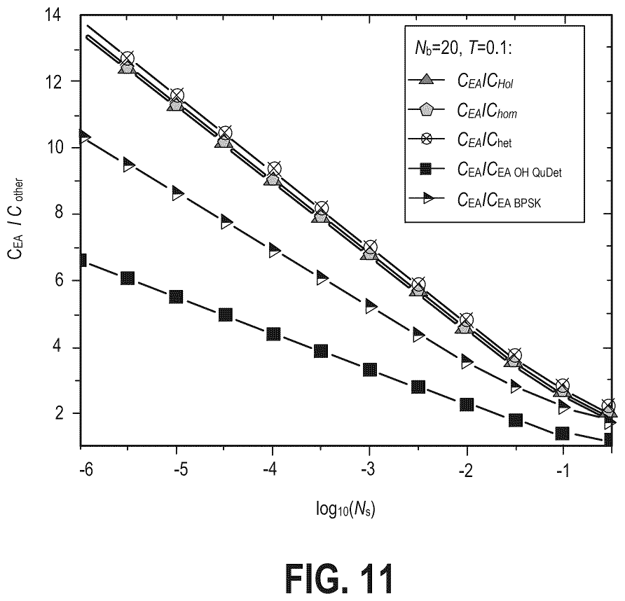

FIG. 11 summarizes how the capacity of disclosed scheme with GM compares against the EA capacity given by equation (35), by setting the simulation parameters as follows: channel transmissivity T=0.1 and average number of background photons N_{b}=20. The capacity of the proposed scheme with GM is significantly better compared to EA BPSK, homodyne, and heterodyne capacities.

Accordingly, the teachings of the present disclosure provides EA schemes, based on Gaussian modulation and the disclosed low-complexity joint receivers, outperforms both the Holevo capacity and classical homo-dyne and heterodyne channel capacities, while employing only single signal-idler pair.

It will be readily apparent to those skilled in the art that any of the components described herein may be known (e.g., off-the-shelf) circuit and/or optical components and/or proprietary circuit and/or optical components that may be used to provide the described functionality and having corresponding input(s) and output(s) to perform the operations described herein. For example, the encoder, receiver, quantum memory, I/Q modulator, attenuator, quantum detector, beam splitter (BS), and entanglement source, as illustrated in FIGS. 1 and 2, may include known (e.g., off-the-shelf) circuit and/or optical components and/or proprietary circuit components and/or optical components to provide the described functionality and having corresponding input(s) and output(s) to perform the operations described above. Similarly, the OPA, photodetector, balanced beam splitter (BBS), amplifier, optical hybrid, balanced detector (BD), phase trimmer, control voltages, Y-junction, and 3 DB couplers, as illustrated in FIGS. 3-8, may include known (e.g., off-the-shelf) circuit and/or optical components and/or proprietary circuit components and/or optical components to provide the described functionality and having corresponding input(s) and output(s) to perform the operations described above. Thus, it is intended that the selection of such components described, as would be understood by those skilled in the art, may be based on, for example, overall performance, engineering tolerances, price/performance conditions, etc.

While the principles of the invention have been described herein, it is to be understood by those skilled in the art that this description is made only by way of example and not as a limitation as to the scope of the invention. Other embodiment are contemplated within the scope of the present invention in addition to the exemplary embodiments shown and described herein.

Modifications and substitutions by one of ordinary skill in the art are considered to be within the scope of the present invention, which is not to be limited except by the following claims.

What is claimed is:

1. A joint receiver for entanglement assisted communication, comprising:
a balanced beam splitter (BBS); and
a balanced detector;
wherein the BBS is configured to mix an input signal mode âₛ and an input idler mode âᵢ to form a mixed beam and to split the mixed beam into a first beam and a second beam and output the first and second beams to the balanced detector, and the balanced detector is configured to receive the first and second beams to convert the first and second beams to an output electrical signal.

2. The joint receiver for entanglement assisted communication of claim 1, wherein the balanced detector includes at least a first and second photodetectors, and an operational amplifier; and the first photodetector is configured to receive the first beam, converts it to electrical domain, and passes the electrical output to the first input of the operational amplifier, and the second photodetector is configured to receive the second beam, converts it to electrical domain, and passes the electrical output to the second input of the operational amplifier.

3. The joint receiver for entanglement assisted communication of claim 2, wherein the first beam is represented as
$$\frac{{\hat{a}}_{s} - {\hat{a}}_{i}}{\sqrt{2}} ,$$
and the second beam is represented as
$$\frac{{\hat{a}}_{s} - {\hat{a}}_{i}}{\sqrt{2}} .$$

4. The joint receiver for entanglement assisted communication of claim 3, wherein the output signal is represented as
$${\hat{a}}_{s}^{†} {\hat{a}}_{i} + {\hat{a}}_{i}^{†} {\hat{a}}_{s} .$$

5. A joint receiver for entanglement assisted communication, comprising:
a 2×2 optical hybrid; and
a balanced detector;
wherein the 2×2 optical hybrid is configured to mix an input signal mode âₛ and an input idler mode âᵢ directly to form a mixed beam and to split the mixed beam into a first beam and a second beam, and output the first and second beams to the balanced detector, and balanced detector is configured to detect the first beam and the second beam, convert the first beam into a first photocurrent electrical signal and convert the second beam into a second photocurrent electrical signal, and to output an electrical signal corresponding to a difference between first photocurrent electrical signal and the second photocurrent electrical signal.

6. The joint receiver for entanglement assisted communication of claim 5, wherein the 2×2 optical hybrid includes a first and second input Y-junctions and first and second output Y-junctions; and the balanced detector includes a first photodetector and a second photodetector; and the first photodetector is configured to receive the first beam and the second photodetector is configured to receive the second beam, and the balanced detector outputs the difference between first photocurrent electrical signal and the second photocurrent electrical signal.

7. The joint receiver for entanglement assisted communication of claim 6, wherein the scatting matrix of the optical hybrid is represented as
$$S = [ \begin{matrix}{e}^{j {ϕ}_{1} \sqrt{1 - κ}} & \sqrt{1 - κ} \\ \sqrt{κ} & {e}^{j {ϕ}_{2} \sqrt{κ}}\end{matrix} ] ,$$
where κ is the power splitting ratio of the Y-junctions, and the scatting matrix transforms the input signal and idler modes to:
$$[ \begin{matrix}{\hat{A}}_{s} \\ {\hat{A}}_{i}\end{matrix} ] = S [ \begin{matrix}{\hat{a}}_{s} \\ {\hat{a}}_{i}\end{matrix} ] .$$

8. The joint receiver for entanglement assisted communication of claim 7, wherein κ=½.

9. A joint receiver for entanglement assisted communication, comprising:
a 2×4 optical hybrid, including a first and second inputs, and first, second, third and fourth outputs;
a first and second balanced detectors;
wherein the 2×4 optical hybrid is configured to receive and to mix an input signal mode âₛ and an input idler mode âᵢ to form a mixed beam, to split the mixed beam into first, second, third, and fourth output beams, and to output the first, second, third, and fourth output beam through the first, second, third and fourth outputs respectively;
the first balanced detector is configured to receive the first and second output beams, and the second balanced detector is configured to receive the third and fourth output beams.

10. The joint receiver for entanglement assisted communication of claim 9, wherein the 2×4 optical hybrid includes a first and second 2×2 optical hybrids, and a first and second Y-junctions.

11. The joint receiver for entanglement assisted communication of claim 10, wherein the first Y-junction is configured to receive the input signal mode âₛ and to split the input signal mode âₛ into a first signal beam and a second signal beam and outputs the first and second signal beams to the first and second 2×2 optical hybrids respectively; and the second Y-junction is configured to receive the input idler mode âᵢ and to split the input idler mode âᵢ into a first idler beam and a second idler beam and outputs the first and second idler to the first and second 2×2 optical hybrids respectively.

12. The joint receiver for entanglement assisted communication of claim 11, wherein the first balanced detector includes a first and second photodetectors, and the second balanced detector includes a third and fourth photodetectors; and the first 2×2 optical hybrid is configured to mix the first signal beam and first idler beam to form a first mixed beam and to split the first mixed beam into the first and second output beams to the first and second photodetectors of the first balanced detector; and the second 2×2 optical hybrid is configured to mix the second signal beam and second idler beam to form a second mixed beam and to split the second mixed beam into the third and fourth output beams to the third and fourth photodetectors of the second balanced detector.

13. The joint receiver for entanglement assisted communication of claim 9, wherein the 2×4 optical hybrid comprises a first, second, third and fourth 3 dB directional couplers and a π/2 phase shift.

14. The joint receiver for entanglement assisted communication of claim 13, wherein each of the first, second, third and fourth 3 dB directional couplers has a first and second coupler inputs and a first and second coupler outputs; the first 3 dB directional coupler is configured to receive the input signal mode âₛ by the first coupler input of the first 3 dB directional coupler, and the second 3 dB directional coupler is configured to receive the input idler mode âᵢ by the first coupler input of the second 3 dB directional coupler; the second coupler inputs of the first 3 dB directional coupler and second 3 dB directional coupler are in vacuum states; the first coupler output of the first 3 dB directional coupler is connected to the π/2 phase shift and further to the first coupler input of the third 3 dB directional coupler; the second coupler output of the first 3 dB directional coupler is connected directly to the first coupler input of the fourth 3 dB directional coupler; the first coupler output of the second 3 dB directional coupler is connected directly to the second coupler input of the third 3 dB directional coupler, and the second coupler output of the second 3 dB directional coupler is connected directly to the second coupler input of the fourth 3 dB directional coupler; the first and second coupler outputs of the third 3 dB directional coupler are the first and second outputs of the 2×4 optical hybrid respectively, and the first and second coupler outputs of the fourth 3 dB directional coupler are the third and fourth outputs of the 2×4 optical hybrid respectively.

15. The joint receiver for entanglement assisted communication of claim 14, wherein the first balanced detector includes a first and second photodetectors, and the second balanced detector includes a third and fourth photodetectors; the first photodetector of the first balanced detector is connected to the first output of the 2×4 optical hybrid and is configured to output a photocurrent i₁, the second photodetector of the first balanced detector is connected to the second output of the 2×4 optical hybrid and is configured to output a photocurrent i₂, the first photodetector of the second balanced detector is connected to the third output of the 2×4 optical hybrid and is configured to output a photocurrent i₃, and the second photodetector of the second balanced detector is connected to the fourth output of the 2×4 optical hybrid and is configured to output a photocurrent i₄; wherein the first balanced detector is configured to output the photocurrent difference between the first photodetector and the second photodetector of the first balanced detector which is i₁−i₂, and the second balanced detector is configured to output the photocurrent difference between the first photodetector and the second photodetector of the second balanced detector which is i₃−i₄.

16. The joint receiver for entanglement assisted communication of claim 15, wherein the input signal mode âₛ comprises an in-phase component and a quadrature component, and the photocurrent difference i₁−i₂ from the first balanced detector corresponds to the in-phase component of the signal mode âₛ, and the photocurrent difference i₃−i₄ from the second balanced detector corresponds to the quadrature component of the signal mode âₛ.
